(19) United States
(12) Patent Application Publication
(10) Pub. No.: US 2011/0181765 A1
(43) Pub. Date: Jul. 28, 2011

(54) IMAGING DEVICE

(75) Inventor: Ken NAKAHARA, Kyoto (JP)

(73) Assignee: ROHM CO., LTD., Kyoto-fu (JP)

(21) Appl. No.: 13/010,276

(22) Filed: Jan. 20, 2011

(30) Foreign Application Priority Data
Jan. 22, 2010 (JP) 2010-12520

(51) Int. Cl. H04N 5/335

(52) U.S. Cl. 348/308; 348/E05.091

(57) ABSTRACT

A circuit unit is formed on a supporting member, and a solid state imaging element is formed on the circuit unit. Also, a lens mechanism is provided on a front surface of the solid state imaging element. The solid state imaging element, the circuit unit and the lens mechanism are mounted in a frame body. In addition, photoelectric conversion elements are attached to the outside of the frame body. Each of the photoelectric conversion elements is configured to have almost no light reception sensitivity to the light wavelength region of more than 300 nm and have sensitivity to the light wavelength region of 300 nm or less. The photoelectric conversion element thus configured can sense particularly flames, electric sparks and the like among ultraviolet light.

### CROSS REFERENCE TO RELATED APPLICATIONS AND INCORPORATION BY REFERENCE

This application is based upon and claims the benefit of prior Japanese Patent Application P2010-12520 filed on Jan. 22, 2010; the entire contents of which are incorporated by reference herein.

### BACKGROUND OF THE INVENTION

1. Field of the Invention

The present invention relates to an imaging device having a function to detect flames, electric sparks and the like.

2. Description of the Related Art

An imaging device including an image pick-up tube, a solid state imaging element and the like forms light emitted from an object to be photographed into an image on a light receiving planar surface of the imaging element by using an optical system such as a lens. The imaging device also photoelectrically converts the light and dark of the image into an amount of charges, and then sequentially reads the amount of charges to be converted into an electric signal.

As the imaging device, there is a monitoring camera installed indoor or outdoor, for example, which normally records a situation in a video.

In a petroleum refining plant or the like, unnecessary flammable gas to be separated and discharged by a purification process has been conventionally ignited and burned by a pilot burner installed at the tip of a chimney, and is then released to the outside. When a pilot flame that is the flame at the tip of the chimney is eliminated, the flammable gas is scattered to the outside without being burned, leading to a problem such as air pollution, environmental pollution or environmental destruction. Thus, it is monitored whether or not the pilot flame is normal, thereby preventing the flammable gas from being discharged to the outside.

For the monitoring of the pilot flame at the tip of the chimney, there is a monitoring method in which a temperature of a burner unit is measured with a temperature sensor attached to a pilot burner. There is also a monitoring method in which a pilot flame is photographed with a monitoring camera.

Meanwhile, as a method for monitoring an abnormality in accumulated materials and the like or in a plant facility such as a wired spot detection system facility and a power plant, it is common to connect various sensors by a wired transmission method and give an alarm after data processing.

On the other hand, there is an automatic fire alarm system as a system for automatically detecting a fire and giving an alarm. For example, as described in Patent Document 1 (Japanese Patent Application Publication No. 2005-115797), the automatic fire alarm system transmits a signal indicating occurrence of a fire from a transmitter when a detector detects physical phenomena (heat, smoke and flame) in case of the fire. Then, a receiver receives these signals, and the place where the fire has occurred is displayed or an acoustic system is set off, thereby letting a building manager or the people in the building know the occurrence of the fire.

Here, in the automatic fire alarm system, a warning area where the detector and the transmitter are installed is isolated from the place where the receiver is installed. Thus, a monitoring camera system is installed, besides the detector, to know the situation in the warning area.

Furthermore, as a device for detecting arson, there has been a device configured to take an image of an arson site by driving a monitoring camera when a flame sensor is activated.

### SUMMARY OF THE INVENTION

Nevertheless, there has heretofore been used a smoke sensor or an infrared sensor to detect occurrence of a fire. The smoke sensor basically detects a change in a light scattering state. However, the smoke sensor has to tolerate a somewhat strong scattering state to avoid a malfunction due to a haze or the like caused by water vapor. As a result, when a fire actually occurs, the smoke sensor does not operate until smoke fills up the area, and thus the fire is detected late, leading to a delayed alarm.

On the other hand, the infrared sensor is suitable for detection of flames because of its high infrared intensity of around several μm emitted by an ordinary flame. However, since infrared from the sun is very strong in this wavelength region, flames cannot be detected outdoor.

Meanwhile, light in an ultraviolet region having a wavelength of 300 nm or less is not included in the solar spectrum as long as there is an ozone layer. However, it has been known that flames and electric sparks generate ultraviolet light having a peak in the vicinity of 230 nm to 280 nm. The flames or electric sparks can be detected outdoor by measuring such ultraviolet light.

As an optical sensor to detect ultraviolet light, a method for extracting, to the outside, carriers generated when light enters, i.e., a photoelectric conversion element configured to detect a photocurrent is used. However, there has not been proposed a photoelectric conversion element sensitive only to ultraviolet light having a wavelength of 300 nm or less. Moreover, there has not been obtained a sensor of a solid state element type capable of quickly detecting flames or electric sparks even outdoor. Accordingly, there has not been achieved a cheap, small and highly impact-resistant imaging device capable of detecting fires, electric sparks and the like.

The present invention has been made to solve the problems described above, and it is an object of the present invention to provide a cheap, small and highly impact-resistant imaging device capable of quickly detecting fires, electric sparks and the like even outdoor.

In order to achieve the object above, a main feature of the present invention is to provide an imaging device including: a substrate; a solid state imaging element formed on the substrate; and a photoelectric conversion element having almost no light reception sensitivity to a light wavelength region of more than 300 nm and having light reception sensitivity to a light wavelength region of 300 nm or less.

The imaging device according to the present invention includes the photoelectric conversion element having almost no light reception sensitivity to a light wavelength region of more than 300 nm and having light reception sensitivity to a light wavelength region of 300 nm or less, in addition to the solid state imaging element to take an image of the situation of a site. The photoelectric conversion element can quickly detect flames, electric sparks and the like outdoor as well as indoor. Moreover, a cheap, small and highly impact-resistant imaging device can be provided.

### BRIEF DESCRIPTION OF DRAWINGS

FIG. 1 is a diagram showing a cross-sectional structure of an imaging device according to the present invention.

FIG. 2 is a signal-flow block diagram of the imaging device according to the present invention.

FIG. 3 is a diagram showing a plane pattern configuration example of a solid state imaging element.

FIG. 4 is a diagram showing a cross-sectional structure example of the solid state imaging element.

FIG. 5 is a diagram showing a cross-sectional structure example in a state where pixels of the solid state imaging element are formed in a two-dimensional pattern.

FIG. 6 is a diagram showing a circuit configuration example of a detection signal extraction unit.

FIGS. 7A to 7D are diagrams showing basic cross-sectional structure examples of a photoelectric conversion element.

FIG. 8 is a diagram showing a cross-sectional structure example of an ultraviolet light detection element.

FIG. 9 is a plan view of the ultraviolet light detection element.

FIG. 10 is a diagram showing another configuration example of the ultraviolet light detection element.

FIG. 11 is a chart showing an electric spark spectrum and a solar spectrum.

FIG. 12 is a chart showing a hydrogen frame spectrum and a solar spectrum.

FIG. 13 is a chart showing a relationship between a band-gap-equivalent wavelength and a Mg content ratio in MgZnO.

FIG. 14 is a chart showing multiple sensitivity curves of a ZnO-based photoelectric conversion element and the hydrogen frame spectrum.

FIGS. 15A to 15C are diagrams showing mode examples of strip-shaped electrodes.

### DETAILED DESCRIPTION OF THE INVENTION

With reference to the drawings, an embodiment of the present invention will be described below. Structural drawings are schematic and different from actual ones. Moreover, the drawings include portions each having dimensional relationships and ratios different from one drawing to another.

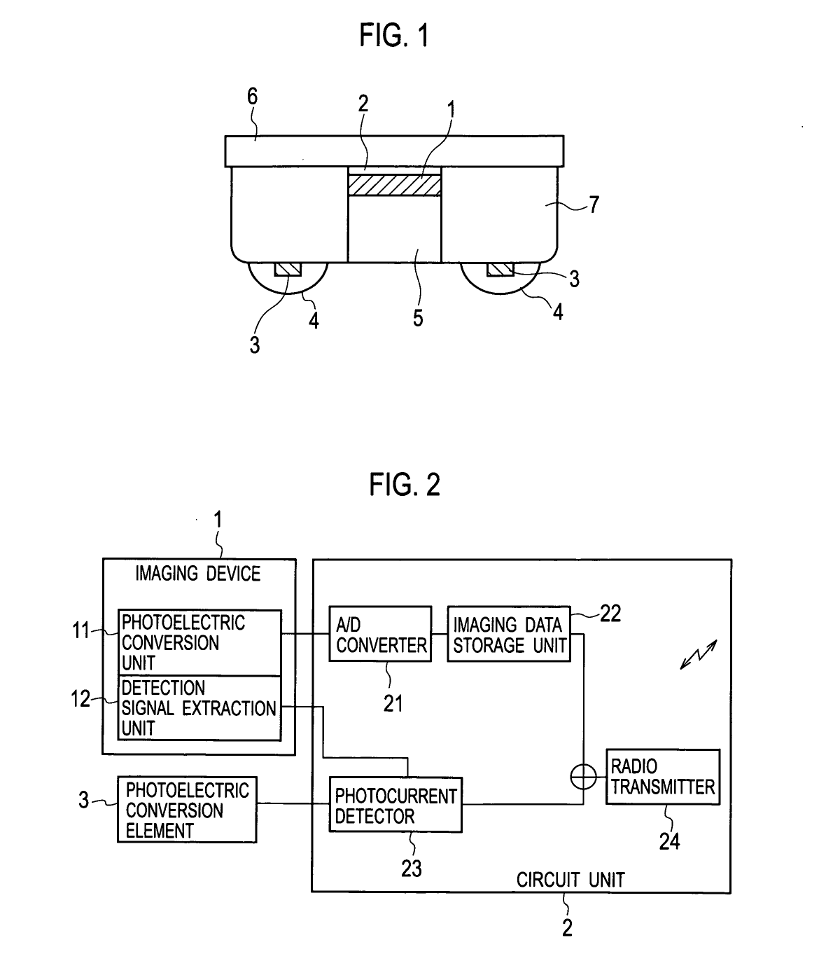

FIG. 1 shows a basic configuration of an imaging device of the present invention. A circuit unit 2 is formed on a supporting member 6, and a solid state imaging element 1 is formed on the circuit unit 2. Also, a lens mechanism 5 is provided on a front surface of the solid state imaging element 1. The lens mechanism 5 is configured to collect and focus light on the solid state imaging element 1, and includes a single lens or a combination of multiple lenses.

The solid state imaging element 1, the circuit unit 2 and the lens mechanism 5 are mounted in a frame body 7. In addition, photoelectric conversion elements 3 are attached to the outside of the frame body 7. Although described later, each of the photoelectric conversion elements 3 is configured to have almost no light reception sensitivity to the light wavelength region of more than 300 nm and have sensitivity to the light wavelength region of 300 nm or less. The photoelectric conversion element 3 thus configured can detect ultraviolet light and can sense flames, electric sparks and the like among the ultraviolet light.

A light receiving surface of the photoelectric conversion element 3 is set in such a manner as to face approximately the same direction as a light receiving surface of the solid state imaging element 1. Here, the photoelectric conversion element 3 is not embedded in the frame body 7 but is formed on a wall surface of the frame body 7 to allow the light receiving surface thereof to receive light from as wide angles as possible. A convex lens 4 also allows light from wider angles to fall on the light receiving surface. The lens 4 is formed of a material which absorbs less ultraviolet light, such as sapphire or high-purity SiO2 such as quartz and crystal.

FIG. 2 shows a relationship among the circuit unit 2, the solid state imaging element 1 and the photoelectric conversion element 3. The solid state imaging element 1 includes a photoelectric conversion unit 11 and a detection signal extraction unit 12. The solid state imaging element 1 is configured so that an imaging signal detected by the photoelectric conversion unit 11 is extracted as an electric signal to the outside by the control of the detection signal extraction unit 12. The imaging signal extracted by the control of the detection signal extraction unit 12 is converted into a digital signal by an A/D converter 21, and the digital signal is stored in an imaging data storage unit 22.

When receiving ultraviolet light having a wavelength of 300 nm or less, which is transmitted through the lens 4, the photoelectric conversion element 3 generates a photocurrent by photoelectric conversion. In order to discriminate the photocurrent from background noises, a photocurrent detector 23 is configured to generate a signal indicating detection of the ultraviolet light having the wavelength of 300 nm or less when the photocurrent reaches a certain threshold current or more.

The detection signal from the photocurrent detection unit 23 is used as a trigger to drive the detection signal extraction unit 12, and thereby the imaging signal is extracted. The data held in the imaging data storage unit 22 is read according to the transmission timing of a radio transmitter 24, and is then wirelessly transmitted to a monitoring center or the like after being added to the detection signal from the photocurrent detector 23.

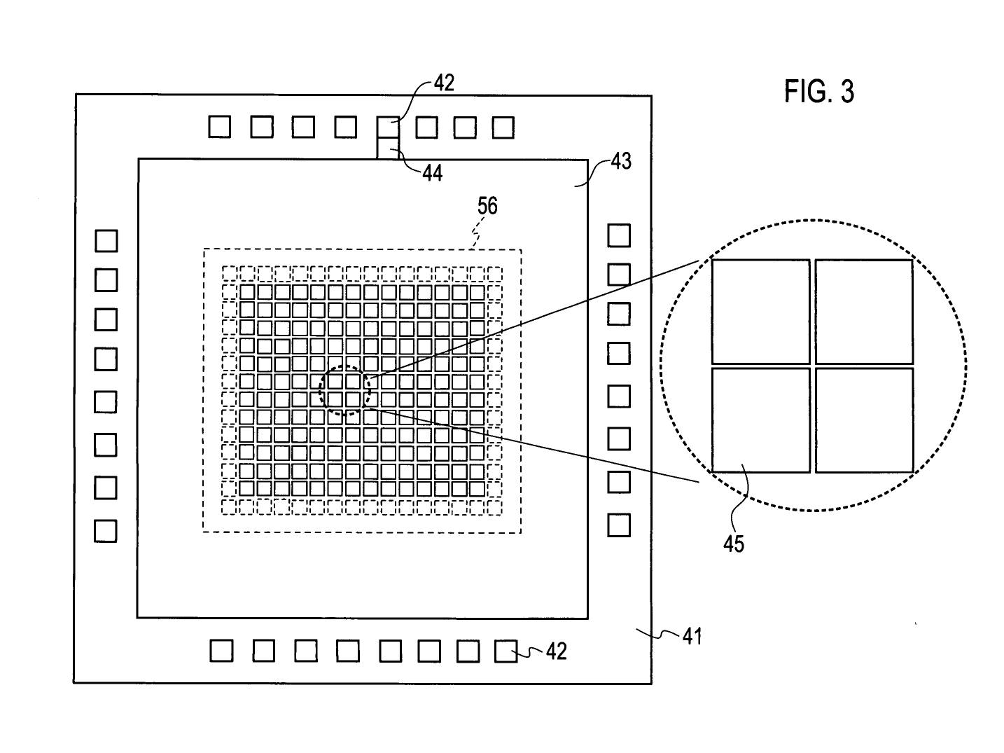

FIG. 3 shows a specific configuration example of the solid state imaging element 1. As shown in FIG. 3, an overall plane pattern configuration of the solid state imaging element 1 includes: a package substrate 41; multiple bonding pads 42 disposed in a peripheral part on the package substrate 41; and an aluminum electrode layer 43 which is connected to one of the bonding pads 42 by a bonding pad connector 44, and is connected, along the peripheral part of the solid state imaging device, to a transparent electrode layer 56 disposed on pixels 45 of the solid state imaging device.

Specifically, the aluminum electrode layer 43 covers an edge region of the transparent electrode layer 56, and is connected to one of the bonding pads 42 by the bonding pad connector 44. Moreover, the pixels 45 are arranged in a matrix pattern in the example shown in FIG. 3. Furthermore, photoelectric converters are formed corresponding to the respective pixels 45 in FIG. 3. Accordingly, the photoelectric converters are also two-dimensionally arranged.

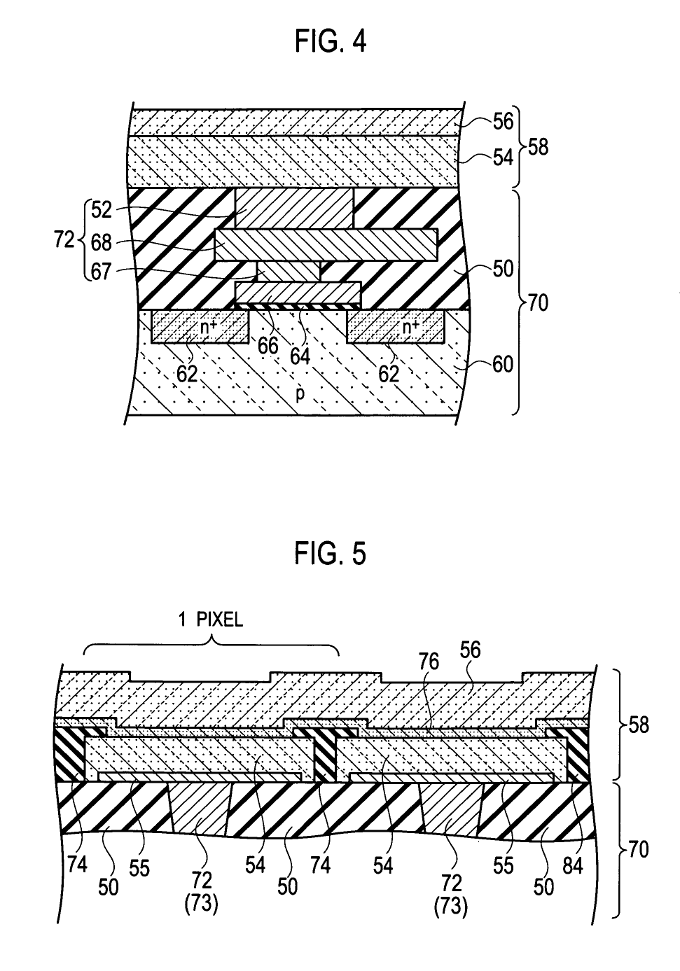

As shown in FIG. 4, a schematic cross-sectional structure of the photoelectric converter includes: a detection signal extraction portion 70 formed on a substrate; and a photoelectric conversion unit 58 disposed on the detection signal extraction portion 70. Here, the photoelectric conversion unit 58 corresponds to the photoelectric conversion unit 11 in the block diagram of FIG. 2, and the detection signal extraction portion 70 corresponds to the detection signal extraction unit 12 in FIG. 2. Note that FIG. 4 omits illustration of a lower electrode layer 55 and a buffer layer 76.

The photoelectric converter shown in FIG. 4 includes: the detection signal extraction portion 70 formed on a semiconductor substrate 60; the lower electrode layer 55 disposed on the detection signal extraction portion 70; a compound semiconductor thin film 54 of chalcopyrite structure disposed on the lower electrode layer 55; the buffer layer 76 disposed on the compound semiconductor thin film 54; and the transparent electrode layer 56 disposed on the buffer layer 76.

The lower electrode layer 55, the compound semiconductor thin film 54, the buffer layer 76 and the transparent electrode layer 56 are sequentially stacked on the detection signal extraction portion 70. Here, the photoelectric converter may have a configuration in which an electrode layer is provided, without the buffer layer, on the compound semiconductor thin film (CIGS) layer.

In the photoelectric converter according to the first embodiment, a reverse bias voltage is applied between the transparent electrode layer 56 and the lower electrode layer 55 to cause impact ionization in the compound semiconductor thin film 54 of chalcopyrite structure, so that the multiplication of charges generated by photoelectric conversion is induced.

The detection signal extraction portion 70 includes a transistor having a gate connected to the lower electrode layer 55. The detection signal extraction portion 70 may be integrated with the lower electrode layer 55, the compound semiconductor thin film 54, the buffer layer 76 and the transparent electrode layer 56, which are sequentially stacked on the detection signal extraction portion 70.

In the photoelectric converter shown in FIG. 4, the compound semiconductor thin film 54 of chalcopyrite structure is formed of Cu(In_{X}, Ga_{1-X})Se₂(0≦X≦1).

As the lower electrode layer 55, molybdenum (Mo), niobium (Nb), tantalum (Ta), tungsten (W), or the like can be used, for example.

As a material to form the buffer layer 76, CdS, ZnS, ZnO, ZnMgO, ZnSe, In₂S₃ or the like can be used, for example.

The transparent electrode layer 56 is formed of a non-doped ZnO film (i-ZnO) disposed on the compound semiconductor thin film 54, and an n-type ZnO film disposed on the non-doped ZnO film (i-ZnO).

The photoelectric converter shown in FIG. 4 can also be configured as a photosensor having sensitivity also in a near infrared light region.

The compound semiconductor thin film 54 includes a high-resistivity layer (i-type CIGS layer) on its surface.

The detection signal extraction portion 70 may include a complementary metal oxide semiconductor field effect transistor (CMOSFET), for example.

FIG. 4 shows an n-channel MOS transistor which constitutes a part of a CMOS in the detection signal extraction portion 70. The detection signal extraction portion 70 includes: the semiconductor substrate 60; source/drain regions 62 formed in the semiconductor substrate 60; a gate insulating film 64 disposed on the semiconductor substrate 60 between the source/drain regions 62; a gate electrode 66 disposed on the gate insulating film 64; a VIA0 electrode 67 disposed on the gate electrode 66; a wiring layer 68 for gates disposed on the VIA0 electrode 67; and a VIA1 electrode 52 disposed on the wiring layer 68.

The gate electrode 66, the VIA0 electrode 67, the wiring layer 68, and the VIA1 electrode 52 are all formed in an interlayer insulating film 50.

A VIA electrode 72 disposed on the gate electrode 66 is formed of the VIA0 electrode 67, the wiring layer 68 disposed on the VIA0 electrode 67, and the VIA1 electrode 52 disposed on the wiring layer 68.

In the photoelectric converter shown in FIG. 4, the photoelectric conversion unit 58 and the gate electrode 66 of the n-channel MOS transistor which constitutes a part of the CMOS are electrically connected to each other by the VIA electrode 72 disposed on the gate electrode 66.

Since an anode of a photodiode which constitutes the photoelectric conversion unit 58 is connected to the gate electrode 66 of the n-channel MOS transistor, optical information detected in the photodiode is amplified by the n-channel MOS transistor.

Note that the detection signal extraction portion 70 can also be formed using a thin film transistor having a CMOS configuration formed on a thin film formed on a glass substrate, for example.

FIG. 5 shows a detailed cross-sectional structure including adjacent pixels of the solid state imaging element formed by two-dimensionally arranging the photoelectric converters shown in FIG. 4.

As is clear from FIG. 5, the lower electrode layer 55 and the compound semiconductor thin film 54 disposed on the lower electrode layer 55 in a pixel cell are separated from those in another pixel cell adjacent thereto by an element isolation region 74 formed of an interlayer insulating film. Moreover, the buffer layer 76 disposed on the compound semiconductor thin film 54 is formed all over the semiconductor substrate surface. Also, the transparent electrode layer 56 is formed over the semiconductor substrate surface, and is made electrically common.

Note that the compound semiconductor thin film 54 and the lower electrode layer 55 may have the same width, or the compound semiconductor thin film 54 may be set to have a larger width than the lower electrode layer 55.

The configuration described above can prevent leakage while filling a void or a pinhole generated in an underlying CIGS thin film with a semi-insulating layer by providing a non-doped ZnO film (i-ZnO) as the transparent electrode layer 56. Therefore, the dark current on the pn junction interface can be reduced by increasing the thickness of the non-doped ZnO film (i-ZnO).

Such a CIGS photoelectric converter is described in detail for its production in the document (Japanese Patent Application Publication No. 2009-259872) on the patent for which an application has already been filed by the inventors of the present invention, and thus can be produced by referring to the document.

Note that although CIGS is used as a compound semiconductor in the configuration of the photoelectric converter of the imaging element 1 in the above example, the photoelectric converter may be of a CMOS type. The CMOS type photoelectric converter can be configured by using, for example, a single crystal silicon layer, forming a part of the single crystal silicon layer in an n-type silicon region, and using the n-type silicon region as a photoelectric conversion region. The CMOS type photoelectric converter may be produced by a publicly well-known method.

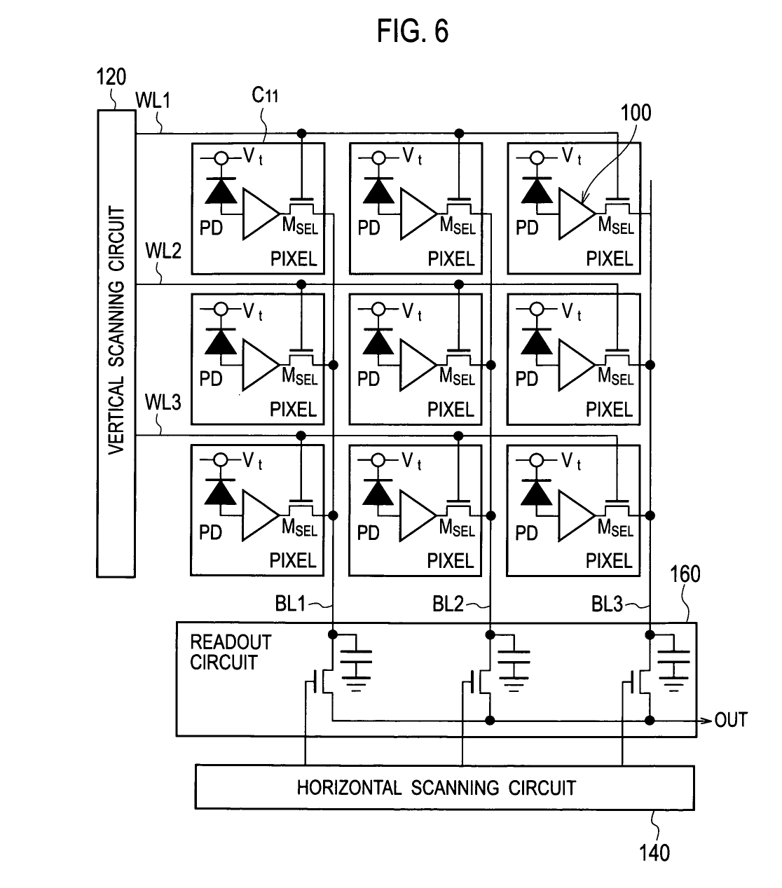

Next, FIG. 6 shows a configuration example of the detection signal extraction unit 12 in the imaging element 1. As shown in FIG. 6, the detection signal extraction unit 12 includes: multiple word lines WLᵢ (where i=1 to m, and m is an integer) disposed in the row direction; multiple bit lines BLⱼ (where j=1 to n, and n is an integer) disposed in the column direction; pixels Cᵢⱼ disposed at the intersections between the word lines WLᵢ and the bit lines BLⱼ; a vertical scanning circuit 120 connected to the multiple word lines WLᵢ; a readout circuit 160 connected to the multiple bit lines BLⱼ; and a horizontal scanning circuit 140 connected to the readout circuit 160. Note that the configuration is shown in the 3×3 matrix pattern in the configuration example of FIG. 6, but can be extended to the matrix of m×n as described above.

A selection MOS transistor M_{SEL} has a gate connected to the word line WL. A target voltage Vₜ (V) is applied to the cathode of a photodiode PD. A capacitor C_{PD} is a depletion layer capacitance of the photodiode PD, and is a capacitor configured to accumulate charges.

The vertical scanning circuit 120 and the horizontal scanning circuit 140 shown in FIG. 6 are driven to read charges accumulated in the capacitors C_{PD} corresponding to the respective pixels, thereby obtaining an imaging signal.

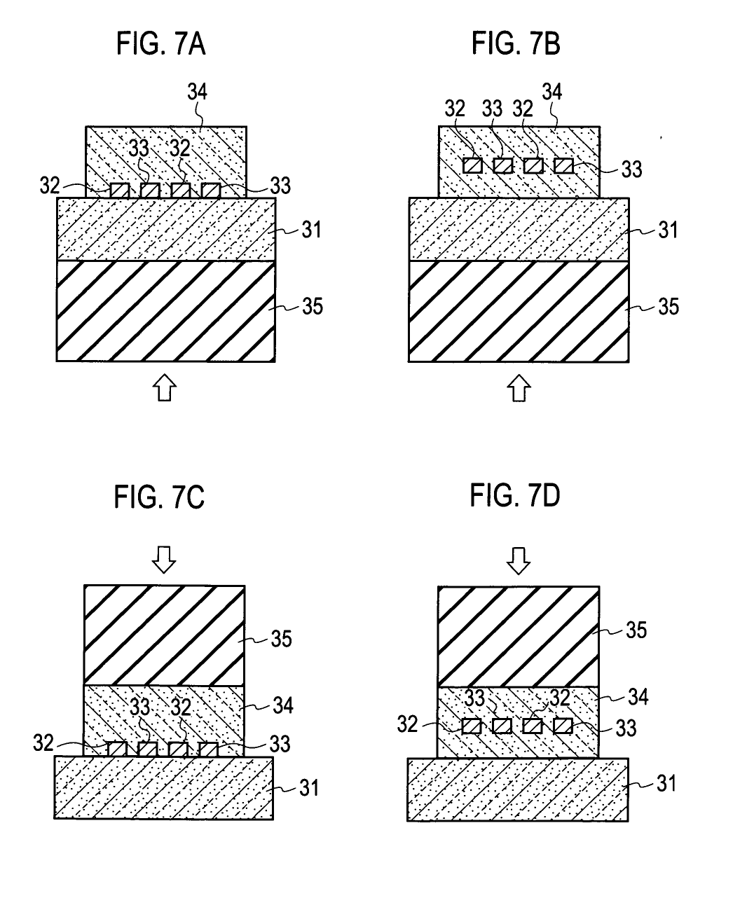

Next, FIGS. 7A to 7D show configuration examples of the photoelectric conversion element configured to have almost no light reception sensitivity to the light wavelength region of more than 300 nm and have sensitivity to the light wavelength region of 300 nm or less.

As an example, an ultraviolet light absorbing layer 34 to be a semiconductor photoelectric conversion layer is formed on a substrate 31, as shown in FIG. 7A. In addition, a filter 35 is formed on a back of the substrate 31. In the ultraviolet light absorbing layer 34, electrodes 32 and 33 are disposed having their carrier detection portions in a buried state. The carrier detection portions of the electrodes 32 and 33 are disposed in contact with the substrate 31.

The filter 35 is configured to transmit therethrough light having a wavelength of 300 nm or less among the wavelength components of light entering from the direction indicated by the arrow. As a configuration example, the filter 35 may be configured to reflect light having a wavelength λ within a range from more than 300 nm to 400 nm or less (300 nm<λ≦400 nm). In any of FIGS. 7B to 7D below, the arrow indicates the light incident direction.

In FIG. 7B, a substrate 31, an ultraviolet light absorbing layer 34 and a filter 35 are disposed in the same manner as those shown in FIG. 7A. However, carrier detection portions of electrodes 32 and 33 are not in contact with the substrate 31 but completely buried in the middle of the ultraviolet light absorbing layer 34.

In FIG. 7C, a filter 35 is formed not on a back of a substrate 31 but on an ultraviolet light absorbing layer 34. Therefore, the substrate 31, the ultraviolet light absorbing layer 34 and the filter 35 are stacked in this order. In the ultraviolet light absorbing layer 34, the electrodes 32 and 33 are disposed with their carrier detection portions buried in the ultraviolet light absorbing layer 34. The carrier detection portions of the electrodes 32 and 33 are disposed in contact with the substrate 31.

In FIG. 7D, a substrate 31, an ultraviolet light absorbing layer 34 and a filter 35 are disposed in the same manner as those shown in FIG. 7C. However, carrier detection portions of electrodes 32 and 33 are not in contact with the substrate 31 but completely buried in the middle of the ultraviolet light absorbing layer 34.

A configuration obtained by removing the filter 35 from the configuration of the photoelectric conversion element shown in each of FIGS. 7A to 7D is the basic configuration of an ultraviolet light detection element. The basic configuration and operation of the ultraviolet light detection element will be described below. The ultraviolet light detection element includes a substrate, an ultraviolet light absorbing layer configured to absorb ultraviolet light, and an electrode configured to measure a current generated in the ultraviolet light absorbing layer.

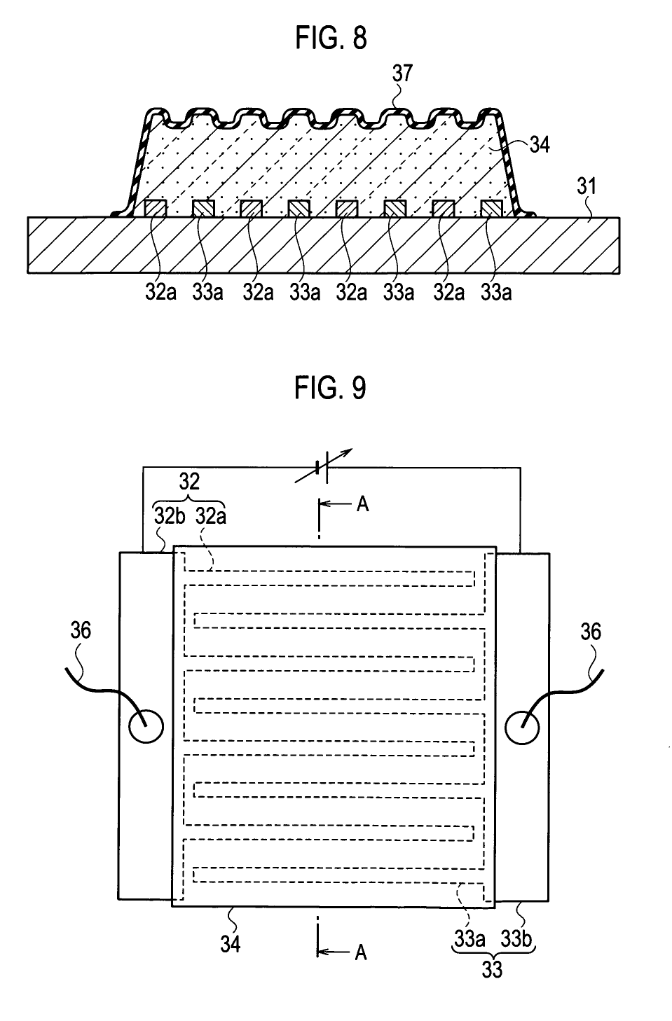

First, as an example of the ultraviolet light detection element, configurations as shown in FIGS. 8 to 10 can be adopted. FIG. 9 is a plan view of the ultraviolet light detection element when seen from above, and FIG. 8 shows a cross-section taken along the line A-A in FIG. 9. Note that, for simplicity, FIG. 8 shows a state where a protective film 37 is removed. Moreover, in FIGS. 8 to 10, the same reference numerals as those of the photoelectric conversion element shown in each of FIGS. 7A to 7D denote the same constituent components. Such constituent components include, for example, the substrate 31, the electrode 32, the electrode 33, the ultraviolet light absorbing layer 34 and the like.

The electrodes 32 and 33 are formed on the substrate 31. The electrode 33 corresponds to a negative electrode when the electrode 32 is a positive electrode, while the electrode 33 corresponds to the positive electrode when the electrode 32 is the negative electrode. As shown in FIG. 9, the electrodes 32 and 33 are formed to have a comb shape. The comb-shaped electrode 32 includes detection electrode parts 32a which are strip-shaped and an extraction electrode part 32b which is a common portion. In the extraction electrode part 32b, the multiple detection electrode parts 32a are integrally formed. Meanwhile, the comb-shaped electrode 33 also includes detection electrode parts 33a which are strip-shaped and an extraction electrode part 33b which is a common portion. In the extraction electrode part 33b, the multiple detection electrode parts 33a are integrally formed. In the example shown in FIGS. 8 and 9, four detection electrode parts 32a and four detection electrode parts 33a are formed. The detection electrode parts 32a and the detection electrode parts 33a are alternately arranged in such a manner as not to overlap with each other.

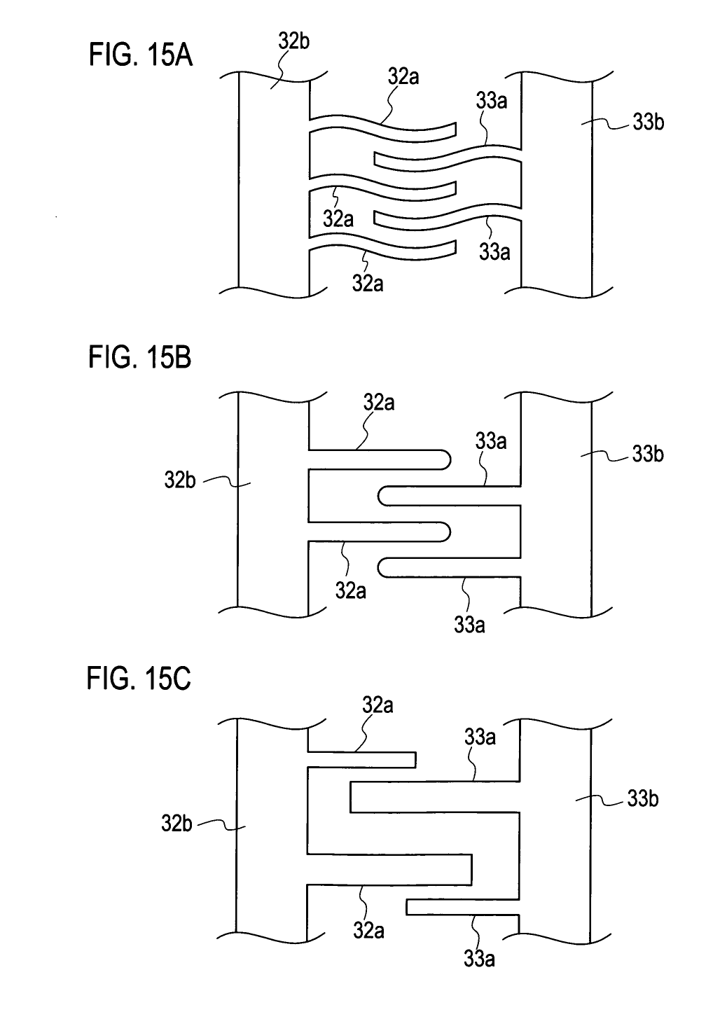

Here, the detection electrode parts 32a and 33a corresponding to the strip-shaped portions of the comb-shaped electrodes may be configured in an alternately nested fashion and can be configured as follows. For example, as shown in FIG. 15A, the detection electrode parts 32a and 33a need not have a rectangular shape but may be formed into a wave-like shape to have curved portions. Moreover, as shown in FIG. 15B, the detection electrode parts 32a and 33a may be formed to have round tips. Furthermore, as shown in FIG. 15C, as to the detection electrode parts 32a and 33a, an electrode width thereof need not be fixed, and a distance between the electrodes need not be fixed. Also, as shown in FIG. 15C, the electrodes need not have the same length.

All the above configurations are called the strip-shaped detection electrode parts in the present invention.

The ultraviolet light absorbing layer 34 is laminated on the electrodes 32 and 33. The ultraviolet light absorbing layer 34 is formed of a material which absorbs ultraviolet light to generate electrons and holes. Specifically, the ultraviolet light absorbing layer 34 is formed of a semiconductor layer or the like having a photoelectric effect. Here, the electrodes are not disposed on the surface of the ultraviolet light absorbing layer, but the detection electrode parts 32a and 33a to directly detect carriers by coming into contact with the ultraviolet light absorbing layer 34 are buried in the ultraviolet light absorbing layer 34.

As seen from FIGS. 8 and 9, surfaces of the detection electrode parts 32a and 33a in contact with the ultraviolet light absorbing layer 34 in the regions of the electrodes 32 and 33 are formed to be entirely covered with the ultraviolet light absorbing layer 34 and thus not to be exposed. Moreover, the ultraviolet light absorbing layer 34 is provided on a part of each of the extraction electrode parts 32b and 33b on the side closer to the detection electrode parts 32a and 33a. In this way, a configuration is achieved in which no electrodes are disposed on the surface of the ultraviolet light absorbing layer 34.

On the extraction electrode parts 32b and 33b, wires 36 are bonded in the regions not covered with the ultraviolet light absorbing layer 34. The extraction electrode parts 32b and 33b are electrode portions to extract, to the outside, a current based on the electrons and holes generated by the ultraviolet light absorbing layer 34 absorbing the ultraviolet light. The current is extracted to the outside through the wires 36. For this reason, a direct-current power supply is connected between the electrodes 32 and 33 as shown in FIG. 9 since a direct-current bias needs to be applied therebetween. Here, the bias voltage is designed to be variable. Note that, in order to extract the detection current to the outside, the electrodes 32 and 33 may be die-bonded with solder to external connection electrodes or the like without using the wires 36.

A material which has high-resistivity and selectively absorbs only the ultraviolet light is preferably used as the ultraviolet light absorbing layer 34. The reason why the high-resistivity is preferable is because it is required to make a distinction between the carriers generated by the ultraviolet light and the current generated by the bias applied to the element. Examples of oxide materials which meet such requirements include ZnO, MgZno, TiO₂, SrTiO₂, InGaNZnO and the like. Also, InGaN, AlGaN, GaN or the like may be used. These are materials having a band gap which does not absorb light in the visible light region, and having a high resistance value. In this embodiment, on the other hand, Mg_{X}Zn_{1-X}O (0≦X) is used.

Meanwhile, for the substrate 31, a high-resistivity transparent material which does not absorb ultraviolet light and does not cause any unnecessary current is preferable, and glass, for example, can be used. For the protective film 37, a material such as SiN and SiO₂ which has a water-proof function, a moisture-proof function, a scratch-proof function, or the like is used. Generally, SiN has better waterproof performance and is thus often used. However, since the ultraviolet light detection element in this example is used to absorb the ultraviolet light for detection, SiN which is easily colored is not preferable, and thus SiO₂ is preferably used. Note that the protective film 37 need not be formed. FIGS. 7A to 7D each correspond to the case where no protective film is formed.

Moreover, since the ultraviolet light absorbing layer 34 is stacked on the detection electrode parts 32a and 33a as shown in FIG. 8, the surface of the ultraviolet light absorbing layer 34 usually has a shape that follows the convex and concave contours of the detection electrode parts 32a and 33a. Furthermore, when the protective film 37 is laminated on the ultraviolet light absorbing layer 34 having the convex and concave contours, the surface of the protective film 37 also usually has a shape that follows the convex and concave contours of the detection electrode parts 32a and 33a. These concaves and convexes act effectively to guide the ultraviolet light into the ultraviolet light absorbing layer 34. When there are no concaves or convexes, total reflection is likely to occur due to a difference in refractive index between an air layer and the ultraviolet light absorbing layer 34 or the protective film 37. On the other hand, the concaves and convexes cause various changes in incident angle of the ultraviolet light, and thus the total reflection can be reduced. As a result, ultraviolet light detection efficiency is improved. While each of FIGS. 7A to 7D shows the ultraviolet light absorbing layer 34 having a flat surface, the ultraviolet light absorbing layer 34 may have a shape having concaves and convexes as described above.

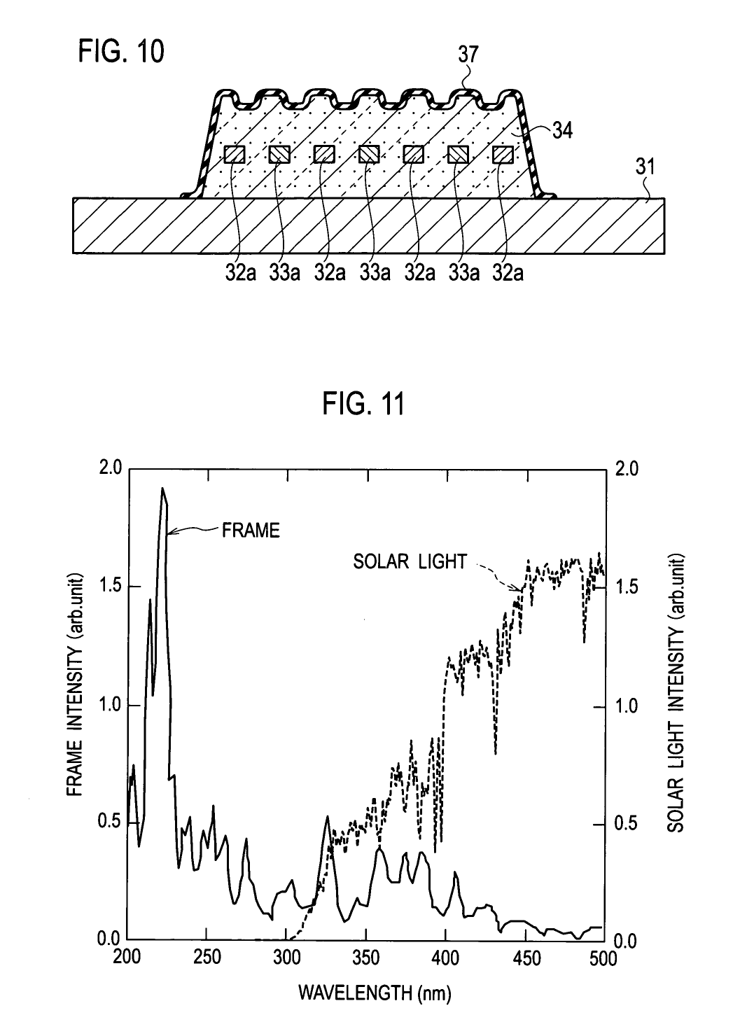

Furthermore, the electrodes 32 and 33 are arranged to come into contact with the substrate 31, and portions of the detection electrode parts 32a and 33a are buried in the ultraviolet light absorbing layer 34. However, a configuration shown in FIG. 10 may be adopted. Specifically, in the configuration shown in FIG. 10, the detection electrode parts 32a and 33a are wrapped around with the ultraviolet light absorbing layer 34. In this case, since the electrodes can be arranged on the film surface side where more light is absorbed, a larger photo-induced current is achieved. Moreover, since the electrodes are distant from the dissimilar interface (glass/ZnO), variation factors are reduced.

Next, the ultraviolet light absorbing layer 34 and the electrodes 32 and 33 are configured to have ohmic contacts with each other. In this embodiment, portions of the detection electrode parts 32a and 33a and the extraction electrode parts 32b and 33b with which the ultraviolet light absorbing layer 34 comes into contact form the ohmic contacts.

When the ultraviolet light absorbing layer 34 and the electrodes 32 and 33 are in ohmic contact with each other, a detection current and a voltage at the time when the amount of ultraviolet light is increased or reduced are in a direct proportional relationship forming linearity. However, in the case of Schottky contact, the detection current and the voltage are not in a proportional relationship. Thus, the detection current proportional to the amount of ultraviolet light cannot be obtained. Furthermore, when there is a changeover point between ON and OFF of ultraviolet light in a region where the detection current is hardly changed, it is difficult to make a distinction between ON and OFF. Therefore, it is important to have an ohmic contact so that a difference in amount of ultraviolet light is measured based on the amount of detection current, in particular.

Moreover, not only the ohmic contact but also the following can be defined in consideration of factors such as resistance to peel-off. When Mg_{X}Zn_{1-X}O (0≦X) is used for the ultraviolet light absorbing layer 34, it is required to use an electrode material having a work function of not less than 4.3 eV and not more than 5.2 eV for the electrodes 32 and 33.

Incidentally, although flames seem to be very visible, what is clearly visible is the light emitted when carbon that is not completely combusted is heated, as disclosed in Japanese Patent Application Publication No. 2004-294423, for example. The carbon is generated as cinders, so-called soot. Flames produced using hydrocarbon gas (such as methane) or highly volatile hydrocarbon, e.g., alcohol (acetone, methanol, ethanol, etc.) or gas mainly containing hydrogen are not likely to generate soot and are seldom visible to the naked eye. It is very difficult to detect the flames with the naked eye particularly outside on a sunny day since there is bright background light. Meanwhile, electric sparks are accompanied by neither infrared light nor heat, unlike the flames, and the sparks are short-lived flash of light and thus hard to detect with the naked eye. In such a case, an ultraviolet detector having no sensitivity to the visible light described above is effective.

FIG. 11 shows comparison between an electric spark spectrum and a solar spectrum. The horizontal axis represents the wavelength (nm), the vertical axis on the left side represents the electric spark intensity (arbitrary unit), and the vertical axis on the right side represents the solar light intensity (arbitrary unit). As can be seen from FIG. 11, the electric spark spectrum has its peak between 200 nm and 250 nm. On the other hand, as to the solar spectrum, the intensity reaches 0 in the wavelength region of 300 nm or less.

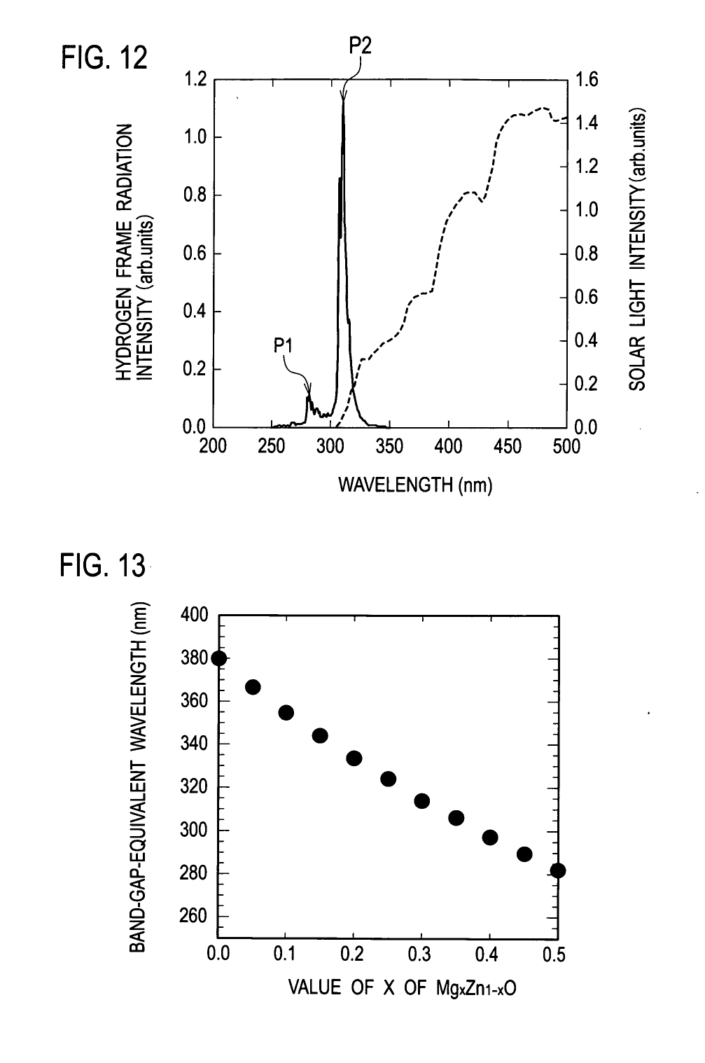

FIG. 12 shows comparison between a hydrogen flame spectrum and a solar spectrum in the atmosphere. The dotted curve indicates the solar spectrum in the atmosphere, while the solid curve indicates the hydrogen flame spectrum. The hydrogen flame spectrum has a peak P1 around the wavelength of 280 nm and a peak P2 around the wavelength of 310 nm.

As can be seen from FIG. 12, peak light P1 around 280 nm is a spectrum component that does not exist in the solar spectrum, and is light that is not included unless there is an ozone hole. Therefore, in order to detect a hydrogen flame outside, it is required to detect the peak P1 without detecting the peak P2. Once the peak P2 is detected, the hydrogen flame cannot be discriminated from the solar light. Thus, by fabricating a ZnO-based photoelectric conversion element having light reception sensitivity only to the wavelength region of 300 nm or less, the flame can be detected without any malfunction due to the solar light. Moreover, as can be seen from the spectrum shown in FIG. 11, by fabricating the ZnO-based photoelectric conversion element having light reception sensitivity only to the wavelength region of 300 nm or less, not only the flame but also electric sparks can be detected without any malfunction due to the solar light.

FIG. 13 is a chart showing a relationship between a value of X in Mg_{X}Zn_{1-X}O and a band-gap-equivalent wavelength (nm) relative to an Mg content ratio. The band-gap-equivalent wavelength is related to an absorption wavelength point (nm) of the semiconductor. The larger the value of X, the shorter the absorption wavelength of Mg_{X}Zn_{1-X}O. As can be seen from FIG. 13, a light reception sensitivity region of the ultraviolet light detection element can be changed by changing the Mg content ratio X in Mg_{X}Zn_{1-X}O.

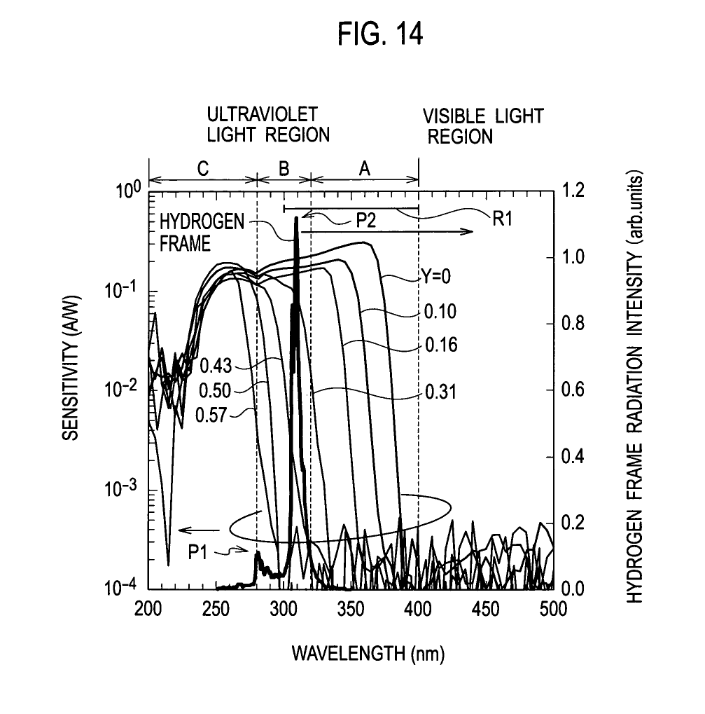

FIG. 14 shows sensitivity curves and the hydrogen flame spectrum when a value of Y in Mg_{Y}Zn_{1-Y}O of the ZnO-based photoelectric conversion element is changed based on the relationship shown in FIG. 13. In FIG. 14, the horizontal axis represents the wavelength (nm), the vertical axis on the left side represents the light reception sensitivity (A/W), and the vertical axis on the right side represents the flame radiation intensity (arbitrary unit). As can be seen from FIG. 14, the wavelength interval is largest when the Mg composition Y is 0, and the larger the Mg composition Y, the smaller the wavelength interval. As described with reference to FIG. 12, in order to make a distinction between the hydrogen flame and the solar light, it is only necessary to detect the vicinity of the peak P1 without detecting the vicinity of the peak P2. To achieve this, the threshold wavelength is set to 300 nm, and the sensitivity curve may be set to have light reception sensitivity only to the wavelength of 300 nm or less and have almost no light reception sensitivity to the wavelength of more than 300 nm.

In order to set the sensitivity curve to have light reception sensitivity only to the wavelength of 300 nm or less and have almost no light reception sensitivity to the wavelength of more than 300 nm, since FIG. 14 shows that the Mg composition Y=0.50 is a boundary, Y in Mg_{Y}Zn_{1-Y}O may be set to 0.5 or more (Y≧0.5). It is expensive to prepare good-quality MgyZn_{1-Y}O so that the Mg composition is 50% or more. To solve this problem, in this example, Mg_{Y}Zn_{1-Y}O (0.05≦Y) is used, i.e., the Mg composition is set as low as 5% or more, and the filter 35 is provided, which cuts a specific wavelength region that is usually commonly used. The filter 35 is configured not to transmit therethrough light in the region R1 shown in FIG. 14, i.e., in the wavelength region of 300 nm<λ≦400 nm (λ is the light wavelength).

A cut-off filter is generally an interference filter formed by alternately laminating films having different refractive indices. Here, a cut band width is determined by a difference in refractive index between the films used. Thus, the difference in refractive index between the films to be laminated needs to be increased to cut off the light in a wide range of wavelength regions. However, it is difficult to select such different materials. Therefore, when the photoelectric conversion element is formed of Si, the wavelength region in which almost all light can be cut off needs to be set as wide as 400 nm to 800 nm or more since the Si photoelectric conversion element has sensitivity to visible light and infrared light. However, it is difficult to form such a cut-off filter.

However, since the ZnO-based photoelectric conversion element is used in the present invention, the sensitivity is 0 in the visible light region as can be seen from FIG. 14. Therefore, in order to allow the sensitivity curve to have the light reception sensitivity only to the wavelength of 300 nm or less, the present invention may be configured to cut off only the light in the wavelength region R1 from more than 300 nm to 400 nm or less (300 nm<λ≦400 nm) by the filter 35. The filter can be relatively easily formed for the wavelength region R1. For example, the filter 35 can be formed to have a structure in which inorganic materials having different refractive indices are alternately stacked in multiple cycles. For example, a TiO₂ film and a SiO₂ film may be selected as dielectric films having different refractive indices, and these films may be alternately stacked in multiple cycles. This laminated film reflects the light in the wavelength region R1, and thus no light reaches the ultraviolet light absorbing layer 34.

Moreover, in order to allow the sensitivity curve to have the light reception sensitivity only to the wavelength of 300 nm or less using only MgZnO, the band gap needs to be increased by setting the Mg composition very high with reference to FIG. 13 and the like. However, when the band gap is significantly increased (e.g., band gap of about 4.5 eV), the element becomes more like an insulator, making it difficult to extract a photocurrent (detection current). However, the use of the filter 35 as described above can prevent an increase in resistivity of the ultraviolet light absorbing layer 34 and enables low-cost production. Thus, the ZnO-based photoelectric conversion element including the filter can be used as a sensor for detecting electric sparks and flames outside.

Meanwhile, the filter 35 may be formed of an Al film in which a number of minute holes of 1 μm or less are formed in arrays, instead of using a laminated film of dielectric films. There is a phenomenon called surface plasmon which occurs mainly on a metal/air interface and a metal/dielectric interface. This surface plasmon phenomenon occurs at an edge of each hole formed in the Al film. A band gap is considered to occur if these holes are present at intervals. Moreover, a change in the interval between the holes or the like leads to a change in cycle, thus causing a change in the light transparent wavelength region. Thus, the film can be used as the filter.

Next, a brief description is given of a method for producing the ultraviolet light detection element and ultraviolet light detector described above. Glass is used for the substrate 31, titanium is used for the electrodes 32 and 33, and Mg_{X}Zn_{1-X}O is used for the ultraviolet light absorbing layer 34.

On the glass substrate, comb-shaped electrodes made of Ti are formed in a thickness of about 50 nm to 300 nm. This step may be performed by a lift-off method or an etching method. From the viewpoint of securing reproducibility, the etching method is preferable when a width of a detection electrode unit of each of the comb-shaped electrodes is about 5 μm or less.

Next, an MgZnO film is formed by sputtering. A film thickness of the MgZnO film is preferably 100 nm or more. If the film thickness is too small, the MgZnO film cannot absorb enough ultraviolet light. Here, when the comb-shaped electrodes are wrapped around with an ultraviolet light absorbing layer as shown in FIG. 10, an MgZnO film is first formed to have a predetermined thickness by sputtering. Thereafter, comb-shaped electrodes made of Ti are formed in a thickness of about 50 nm to 300 nm as described above. Subsequently, another MgZnO film is formed by sputtering.

Next, in order to secure a wire bonding region of the comb-shaped electrode, the MgZnO film covering the edge of the comb-shaped electrode is removed by etching with diluted hydrochloric acid. Dry etching may be used, but wet etching is easy since the ZnO material is likely to leave residues.

Thereafter, a filter 35 is formed. The filter 35 is formed by alternately laminating TiO₂ films and SiO₂ films using a sputtering method or the like.

Subsequently, the glass substrate is ground to be thin. There is no particular problem even if the substrate is not reduced in thickness. However, when it is wished to produce a thin ultraviolet light detector, it is preferable to reduce the thickness of the element since the package can be reduced in thickness as well.

The ultraviolet light detection element thus completed is packaged in a frame body 7 as shown in FIG. 1, for example, by die bonding with Ag paste, epoxy resin or the like.

The configuration of the imaging device of the present invention is widely applicable to monitoring of a petroleum refining plant, an automatic fire alarm system, an arson detection system and the like.

What is claimed is:

1. An imaging device comprising:
a substrate;
a solid state imaging element formed on the substrate; and
a photoelectric conversion element having almost no light reception sensitivity to a light wavelength region of more than 300 nm and having light reception sensitivity to a light wavelength region of 300 nm or less.

2. The imaging device of claim 1, wherein:
the solid state imaging element starts imaging upon detection of a photocurrent of the photoelectric conversion element, and imaging data is wirelessly transmitted to the outside.

3. The imaging device of claim 1, wherein:
the solid state imaging element is formed of a silicon CMOS image sensor.

4. The imaging device of claim 2, wherein:
the solid state imaging element is formed of a silicon CMOS image sensor.

5. The imaging device of claim 1, wherein:
the solid state imaging element includes
a detection signal extraction unit configured to extract an imaging signal, and
a compound semiconductor of chalcopyrite structure containing Cu as a photoelectric conversion unit.

6. The imaging device of claim 2, wherein:
the solid state imaging element includes
a detection signal extraction unit configured to extract an imaging signal, and
a compound semiconductor of chalcopyrite structure containing Cu as a photoelectric conversion unit.

7. The imaging device of claim 1, wherein:
a plurality of the photoelectric conversion elements are provided.

8. The imaging device of claim 2, wherein:
a plurality of the photoelectric conversion elements are provided.

9. The imaging device of claim 1, wherein:
the photoelectric conversion element includes an optical filter configured to transmit light having a wavelength of 300 nm or less.

10. The imaging device of claim 1, wherein:
the photoelectric conversion element includes an optical filter configured to reflect light having a wavelength λ within a range of 300 nm<λ≦400 nm.

11. The imaging device of claim 9, wherein:
the optical filter is formed by laminating dielectric films.

12. The imaging device of claim 10, wherein:
the optical filter is formed by laminating dielectric films.

13. The imaging device of claim 9, wherein:
the optical filter is formed of an Al film having minute holes of 1 μm or less formed in arrays.

14. The imaging device of claim 10, wherein:
the optical filter is formed of an Al film having minute holes of 1 μm or less formed in arrays.

15. The imaging device of claim 1, wherein:
a semiconductor photoelectric conversion layer of the photoelectric conversion element is formed of a ZnO-based semiconductor.

16. The imaging device of claim 2, wherein:
a semiconductor photoelectric conversion layer of the photoelectric conversion element is formed of a ZnO-based semiconductor.

17. The imaging device of claim 3, wherein:
a semiconductor photoelectric conversion layer of the photoelectric conversion element is formed of a ZnO-based semiconductor.

18. The imaging device of claim 15, wherein:
the ZnO-based semiconductor is Mg_{X}ZnO_{1-X} (X≧0.05).

19. The imaging device of claim 16, wherein:
the ZnO-based semiconductor is Mg_{X}ZnO_{1-X} (X≧0.05).

20. The imaging device of claim 17, wherein:
the ZnO-based semiconductor is Mg_{X}ZnO_{1-X} (X≧0.05).
